(19) United States
(12) Patent Application Publication
(10) Pub. No.: US 2005/0151840 A1
(43) Pub. Date: Jul. 14, 2005

(54) Method and system for setting up a multicast or broadcast transmission

(76) Inventor: Tuija Hurtta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/511,106

(22) PCT Filed: Jun. 19, 2002
(86) PCT No.: PCT/IB02/02278

(30) Foreign Application Priority Data
Apr. 17, 2002 (WO) PCT/IB02/01245

(51) Int. Cl. H04N 7/18; H04N 9/47; H04N 7/00

(52) U.S. Cl. 348/61; 348/844

(57) ABSTRACT

The present invention relates to a method and system for setting up a broadcast or multicast transmission to a plurality of terminal devices (10) via a first switching node (40) and a second switching node (30) of a data network, wherein an information indicating the number of connections required between the second switching node (30) and the plurality of terminals (10) is provided to the first switching node (40), so that the first switching node (40) may determine based on the provided information a number of connections to be set up between the first switching node (40) and the second switching node (30). Thereby, the number of connections between the first and second switching nodes can be equalized so as to reduce signal duplication and parameter adaptation requirements at said second switching node (30).

### FIELD OF THE INVENTION

The present invention relates to a method and system for setting up a multicast or broadcast transmission, which may be used, e.g., for context activation in a Multicast/Broadcast Multimedia Service (MBMS) architecture.

### BACKGROUND OF THE INVENTION

With increasing use of high bandwidth applications, e.g. multimedia applications, in third generation mobile systems, especially with a large number of users receiving the same high data rate services, efficient information distribution is essential.

Broadcast and Multicast are methods for transmitting data from a single source to several destinations, i.e., point-to-multipoint transmissions. At present, for cellular networks, two corresponding services are defined in release-99 and release-4 of the 3^{rd} Generation Partnership Project (3GPP) specifications. First, a cell broadcast service (CBS) allows low bit-rate data to be transmitted to all subscribers in a set of given cells over a shared broadcast channel. This message-based services are defined in the 3GPP specifications TS 25.324 and TS 23.041. Second, an Internet Protocol (IP) based IP-Multicast service allowing mobile subscribers to receive multicast traffic is defined in the 3GPP specifications TS 22.060 and TS 23.060 and TS 29.061. However, this service does not allow multiple subscribers to share radio or core network resources and as such does not offer any advantages with respect to resource utilization within the core network (CN) and/or over the radio access network (RAN).

For some applications, it is envisaged that multiple users can receive the same data at the same time. The benefit of multicast and broadcast in the network is that the data is sent once on each link. For example, a core network switching node, e.g. a Serving General Packet Radio Services (GPRS) Support Node (SGSN), will send data only once to a RAN switching node, e.g. a Radio Network Controller (RNC), regardless of the number of base stations, e.g. Node Bs, and mobile stations, e.g. user equipments (UE), that wish to receive it. The benefit of multicast and broadcast on the air interface is that many users can receive the same data on a common channel, thus not clogging the air interface with multiple transmissions of the same data. Hence, broadcast and multicast are techniques to decrease the amount of data within the network and use resources more efficiently.

The MBMS is defined e.g. in the 3GPP specifications TS 22.146 and TR 23.846 as a point-to-multipoint bearer service which provides the above capability for broadcast/multicast services. In a broadcast mode, a unidirectional point-to-multipoint transmission is provided for multimedia data (e.g. text, audio, picture, video) from a single source entity to all users in a broadcast area or areas. A broadcast service might, for example, consist of a single on-going session (e.g. a media stream such as an advertising or a welcome message to the network) or may involve several intermittent sessions over an extended period of time (e.g. messages). In a multicast mode, a unidirectional point-to-multipoint transmission of multimedia data is provided from a single source point to a multicast group in a multicast area. Thus, in the multicast mode, there is a possibility for the network to selectively transmit to cells within the multicast area which contain members of a multicast group. Similarly, a multicast service might, for example, consist of a single on-going session (e.g. a media stream such as a subscribed football results service) or may involve several intermittent sessions over an extended period of time (e.g. messages). The broadcast and the multicast mode may generate charging data for the end user and generally may require a subscription. Both broadcast and multicast modes are intended to efficiently use radio/network resources e.g. by transmitting data over a common radio channel.

In the known MBMS architecture as defined in the above specifications, a SGSN and a GGSN maintains one or many logical connection(s) in order to route MBMS data to relevant UEs. The SGSN duplicates data packets received from the GGSN through a single GPRS Tunneling Protocol (GTP) tunnel and forwards the received data packets and duplicated data packets, respectively, via corresponding GTP tunnels to each RNC involved in the provision of a specific MBMS service. The GGSN duplicates data packets received from the MBMS data source for forwarding to each SGSN to which a GTP tunnel has been established for the specific MBMS service.

However, due to the fact that only one GTP tunnel is established between the GGSN and the respective SGSN, considerable changes are required at the SGSN to provide additional processing power and logic functionality for packet duplication and adaptation of individual logical connection parameters at the SGSN.

### SUMMARY OF THE INVENTION

It is therefore an object of the present invention to provide a method and system for logical connection setup in a broadcast or multicast transmission, by means of which required changes at the SGSN can be reduced.

This object is achieved by a method of setting up a broadcast or multicast transmission to a plurality of terminal devices via a first switching node and a second switching node of a data network, said method comprising the steps of:
providing to said first switching node an information indicating the number of connections required between said second switching node and said plurality of terminals; and
determining based on said provided information a number of connections to be set up between said first switching node and said second switching node.

Furthermore, the above object is achieved by a system for setting up a broadcast or multicast transmission to a plurality of terminal devices via a first switching node and a second switching node of a data network,
wherein said first switching node is arranged to set up an initial connection to said second switching node, and wherein said second switching node is arranged to transmit to said first switching node via said initial connection an information indicating the number of connections required between said second switching node and said plurality of terminals; and
wherein said first switching node is arranged to determine based on said provided information a number of connections to be set up between said first switching node and said second switching node.

Additionally, the above object is achieved by a switching node for setting up a broadcast or multicast transmission to a plurality of terminal devices via another switching node of a data network,
wherein said switching node is arranged to access a memory table in order to derive an information indicating the number of connections required between said other switching node and said plurality of terminals; and
wherein said switching node is arranged to determine based on said derived information a number of connections to be set up to said other switching node.

Finally, the above object is achieved by a switching node for setting up a broadcast or multicast transmission to a plurality of terminal devices via another switching node of a data network,
wherein said switching node is arranged to query, using a multicast identification or a multicast area identification, from an address server an information indicating the number of connections required between said other switching node and said plurality of terminals; and
wherein said switching node is arranged to determine based on said queried information a number of connections to be set up to said other switching node.

Accordingly, the number of connections required at the second switching node can be made available to the first switching node, so that the number of connections between the first switching node and the second switching node can be adapted correspondingly, e.g. made equal, to thereby reduce the processing amount for conversion, relaying and adaptation of data flows and connection parameters at the first switching node.

In particular, in an MBMS architecture, less changes are required at the SGSN for the following reasons. If the number of connections, i.e. GTP tunnels, determined at the GGSN is selected to be equal to the signaled number, packet relaying in the SGSN may work in a similar way as in a point-to-point connection without any duplication of packets from a Gn/Gp GTP tunnel between the SGSN and the GGSN to multiple Iu GTP tunnels between the SGSN and the RNCs. Moreover, logical connection parameters, such as QoS, do not require changes to the SGSN. RNCs may be able to provide different values of the connection parameters for GTP tunnels, e.g. RNC1 could provide QoS1, whereas RNC2 could provide QoS2. If there is only one Gn/Gp GTP tunnel, a new logic is required in the SGSN to determine QoS for the Gn/Gp GTP tunnel, e.g. the highest or lowest QoS which any RNC can provide.

Furthermore, RAB (Radio Access Bearer) release and Iu release do not require changes to the SGSN. If there is only one Gn/Gp GTP tunnel, new logic is required to the SGSN, i.e. set max bitrate of the logical connection to 0 only when all RABs related to the multicast ID and/or multicast area ID are released.

The information about the number of connections or tunnels can be obtained by setting up an initial connection between the first and second switching nodes, and by transmitting the information from the second switching node to the first switching node in response to a request of the first switching node. In particular, the information may be transmitted in a response message to a context activation request. Alternatively, the information may be transmitted in a response message to an identification request issued by said first switching node. A context activation for the determined number of connections may then be requested by the first switching node in response to the receipt of the response message. As an alternative, the context activation for the determined number of connections may be requested by the second switching node after the transmission of the response message.

As an alternative to the initial connection, the first switching node may obtain the information about the number of connections without involving the second switching node. The information may be stored in a memory table accessible by the first switching node or may be obtained based on a query to an address server, e.g. a DNS query.

Advantageous further developments are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a general architecture of an MBMS architecture for implementing the preferred embodiments of the present invention;

FIG. 2 shows a schematic signaling and processing diagram indicating setup of a multicast transmission according to a first preferred embodiment;

FIG. 3 shows a schematic signaling and processing diagram indicating setup of a multicast transmission according to a first example of a second preferred embodiment;

FIG. 4 shows a schematic signaling and processing diagram indicating setup of a multicast transmission according to a second example of the second preferred embodiment;

FIG. 5 shows a schematic signaling and processing diagram indicating setup of a multicast transmission according to a third example of the second preferred embodiment;

FIG. 6 shows a schematic signaling and processing diagram indicating a connection setup if a terminal device joins a multicast or broadcast service; and

FIG. 7 shows a schematic signaling and processing diagram indicating an activation procedure if a terminal device joins a multicast or broadcast service.

### DESCRIPTION OF THE PREFERRED EMBODIMENTS

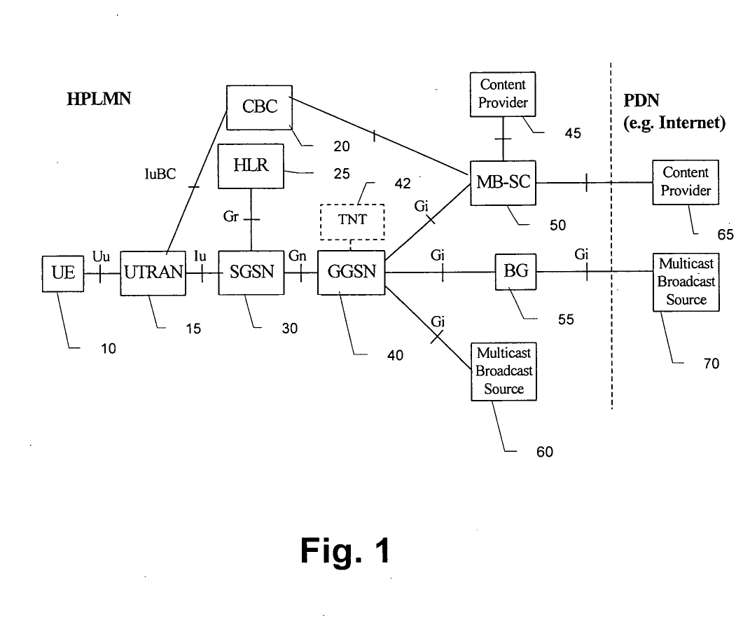

The first and second preferred embodiments will now be described on the basis of an MBMS architecture as shown in FIG. 1.

According to FIG. 1, the MBMS architecture comprises an SGSN 30 which performs user individual control functions and concentrates individual users of the same MBMS service into one or many logical connections. The SGSN 30 maintains a logical connection (e.g. MBMS context) in order to route MBMS data to relevant UEs. The logical connection is maintained also by a GGSN 40. The SGSN 30 forwards the packets received via one or many GTP tunnels from the GGSN 40 to each RNC of a UTRAN (Universal Mobile Telecommunications System (UMTS) Terrestrial Radio Access Network) 15, involved in the provision of a specific MBMS service.

The GGSN 40 terminates the MBMS GTP tunnels from the SGSN 30. The GGSN classifies MBMS data sent by the MBMS data source into relevant logical connections. The GGSN 40 duplicates the MBMS data packets received from the MBMS data source for forwarding to each SGSN to which GTP tunnels are established for a specific MBMS service.

Furthermore, a Multicast/Broadcast-Service Center (MB-SC) 50 is provided for control purposes and to send or forward MBMS data. MBMS data may be scheduled in the MB-SC 50, e.g. for transmission to users every hour. It offers interfaces over that a content provider 65 of an external packet data network (PDN), e.g. the Internet, can request data delivery to users.

A Cell Broadcast Center (CBC) may be connected between the MB-SC 50 and the UTRAN 15 to announce MBMS services to users.

The architecture allows for other MBMS broadcast/multicast data sources. PLMN internal data sources 60 may directly provide their data. Data delivery by external data sources 70 of a PDN is controlled by Border Gateways (BG) 55 which may allow for example data from single addresses and ports to pass into the PLMN (PLMN) of a specific user equipment (UE) 10 for delivery.

To provide an MBMS transmission, the SGSN 30 authenticates users and authorizes usage of services/resources based on subscription data stored in a home location register (HLR) 25. Additionally, the SGSN 30 provides user individual service control and mobility management, may limit the service area per individual user, stores logical connection information per activated service per individual user or per multiple users, generates charging data per service for each user and for each logical connection, and establishes RABs on demand when data have to be transferred to the users, e.g. to the UE 10.

The functions of the GGSN 40 for MBMS connections comprise storing logical connection information per activated service per individual user or per multiple users, data classification, charging data collection, tunneling of data, service (QoS) negotiation, and data policing.

The tunneling, i.e. encapsulation of data packets into new packets with new headers, is an important GGSN function for MBMS. It allows the provision of HPLMN MBMS multicast services to users roaming in a Visited PLMN (VPLMN). The tunneling separates the data of the different MBMS services from each other and allows therefore the use of the same addresses in HPLMN and VPLMN. A coordination of addresses between different PLMNs is not needed.

According to the preferred embodiments, an information about the number of required logical connections between the SGSN 30 and the RNCs in UTRAN 15 involved in a specific MBMS data transmission are provided to the GGSN 40. Thereby, the GGSN 40 is capable to adapt the number of GTP tunnels set up to the SGSN 30 via the Gn or Gp interface to the number of GTP tunnels at the Iu interface between the SGSN 30 and the RNC in the UTRAN 15. This adaptation functionality can be used to set up equal numbers of GTP tunnels via the Iu interface and the Gn or Gp interface, so that the processing at the SGSN 30 corresponds to the processing of a point-to-point logical connection (e.g. a PDP context), as an own Gn or Gp GTP tunnel can be allocated to each Iu GTP tunnel. Thus, a duplication of data packets is only required at the GGSN 40. Moreover, logical connection parameters, e.g. QoS, can be maintained, as one GTP tunnel is established between the SGSN 30 and the RNC in the UTRAN 15 for each GTP tunnel between the SGSN 30 and the GGSN 40.

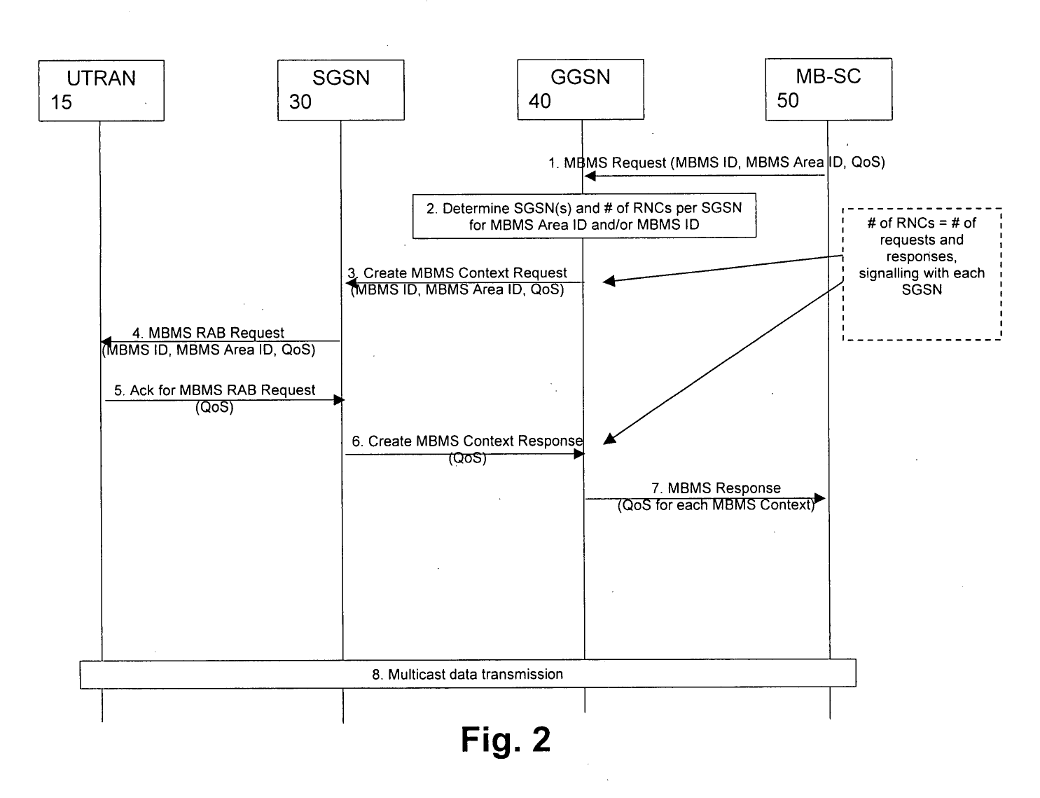

In the following, the setup of an MBMS downlink transmission according to the first and second preferred embodiments is described in greater detail for a multicast data transmission with reference to the step numbers indicated in FIGS. 2 to 5.

FIG. 2 shows a schematic diagram indicating signaling and processing functions for setting up an MBMS transmission according the first preferred embodiment. In the first preferred embodiment, the GGSN 40 is arranged to obtain the number of Iu GTP tunnels, i.e. the number of RNCs in the UTRAN 15 per each SGSN, required for a specific MBMS service by accessing a corresponding memory table (TNT) 42 which may be provided at or in the GGSN 40 and which is thus accessible by the GGSN 40. In the memory table 42, the required number of RNCs or Iu GTP tunnel connections per each SGSN is stored for every MBMS identification (ID) and/or MBMS area ID.

In step 1, an MBMS request with an MBMS ID indicating the MBMS service, an MBMS area ID indicating the specific multicast or broadcast area in which the MBMS service is to be received, and a required QoS is transmitted from the MBSC 50 to the GGSN 40. Based on the received MBMS area ID and/or MBMS ID, the GGSN 40 determines SGSN(s) serving the identified MBMS area and/or MBMS service and addresses the memory table 42 to obtain the number of RNCs per each SGSN involved in the MBMS data transmission (step 2). Then, the GGSN 40 transmits for every identified RNC a context activation request with the corresponding MBMS-specific and QoS information to the SGSN 30 to establish corresponding GTP tunnels (step 3). In response thereto, the SGSN 30 issues MBMS RAB requests comprising the same or modified MBMS-specific and QoS information to the UTRAN 15 to set up the required number of radio access bearers (step 4). In steps 5 and 6, the MBMS RAB and MBMS context activation requests are acknowledged to the SGSN 30 and the GGSN 40, respectively. As already mentioned, steps 3 to 6 are repeated in accordance with the number of RNCs to be connected. Thus, the obtained number of RNCs corresponds to the number of requests and responses (acknowledgements), while signaling may be performed with one or several SGSNs depending on the desired MBMS area and/or MBMS service. When all contexts and radio access bearers have been established successfully, the GGSN 40 forwards an MBMS response message with QoS information for each activated context to the MB-SC 50 (step 7) and the MBMS data transmission can be started in step 8.

According to a modification of the first preferred embodiment, the number of RNCs or Iu GTP tunnels may be obtained in step 2 by performing a query to an address server, e.g. a DNS query, using the MBMS ID and/or MBMS area ID. Then, the memory table 42 could be dispensed with, as in the second preferred embodiment described in the following.

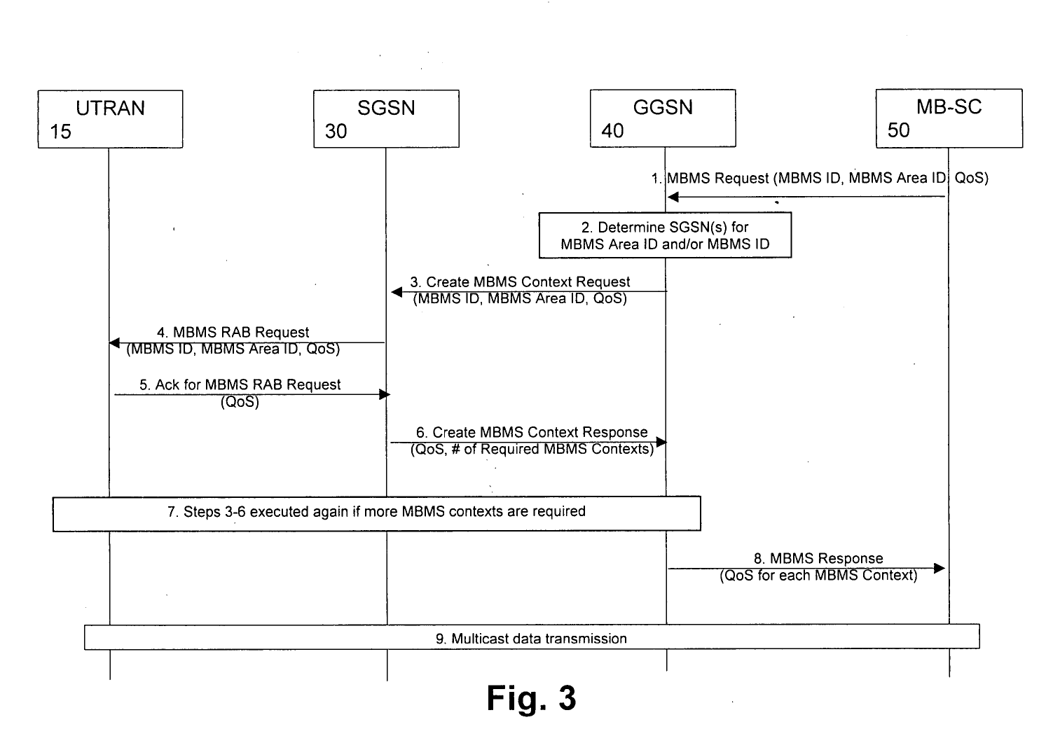

FIG. 3 shows a signaling and processing diagram according to a first example of the second preferred embodiment. In the second preferred embodiment, the GGSN 40 obtains the information from the SGSN 30 in a respective signaling message. According to the first example, the GGSN 40 determines the SGSN(s) involved in the MBMS service based on the MBMS area ID and/or MBMS ID received in step 1 with the MBMS request (step 2). Then, steps 3 to 6 are performed once as described in the first embodiment, while contrary to the first embodiment, the number of RNCs involved is now signaled by the SGSN 30 in the context activation response message of step 6. Then, the GGSN 40 is aware of the number of required GTP tunnels towards the SGSN 30 and steps 3 to 6 may be executed again until the required number of GTP tunnels and radio access bearers are established in step 7. If so, an MBMS response message with QoS information for each activated context is forwarded to the MB-SC 50 in step 8, and the MBMS data transmission can start in step 9.

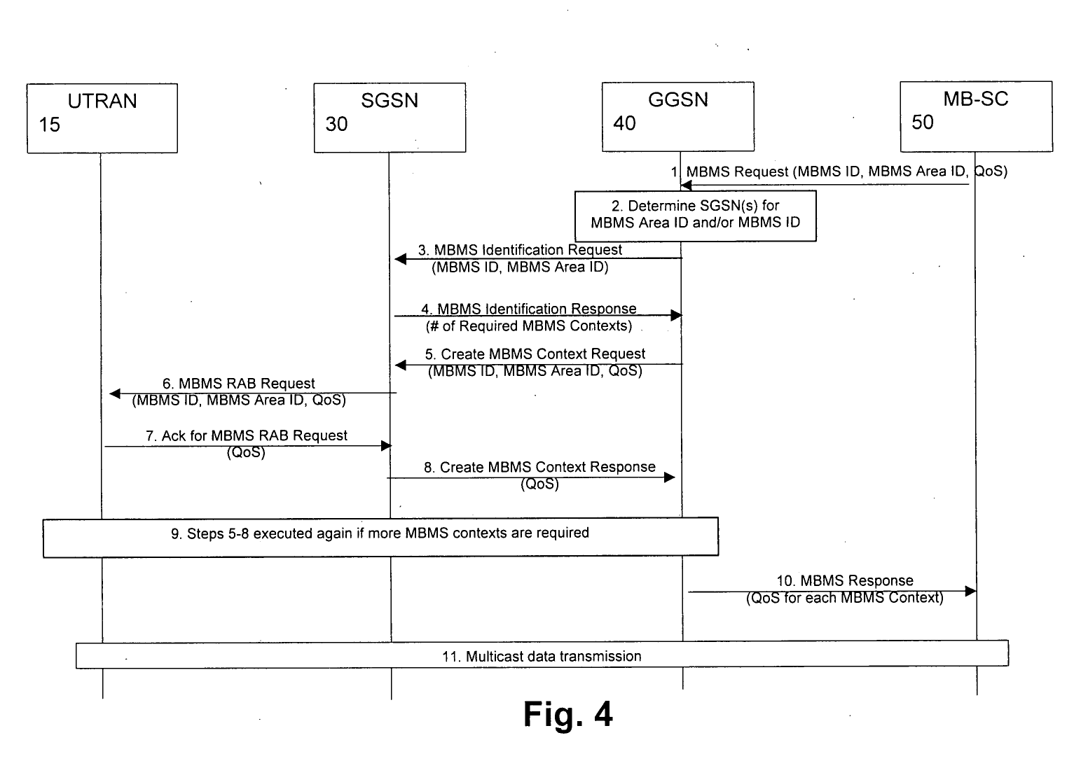

FIG. 4 shows a signaling and processing diagram according to a second example of the second preferred embodiment. In the second example, the number of RNCs involved in the MBMS service is signaled by a separate signaling procedure, as indicated by steps 3 and 4 of FIG. 4. After having determined the concerned SGSN(s) based on the MBMS area ID and/or MBMS ID, the GGSN 40 forwards to each concerned SGSN, e.g. also the SGSN 30 shown in FIG. 4, an MBMS identification request message with the MBMS ID and the MBMS area ID. In response thereto, the SGSN 30 issues an MBMS identification response message including the required number of RNCs to the GGSN 40. The remaining steps 6 to 11 correspond to steps 3 to 9 of FIG. 3 and thus do not have to be explained again, except for the difference in step 8 of FIG. 4, where only the QoS information is forwarded and no longer the number of required RNCs which is now already known at the GGSN 40. Furthermore, only steps 5 to 8 are repeated for each required MBMS context. Steps 3 and 4 are performed only once.

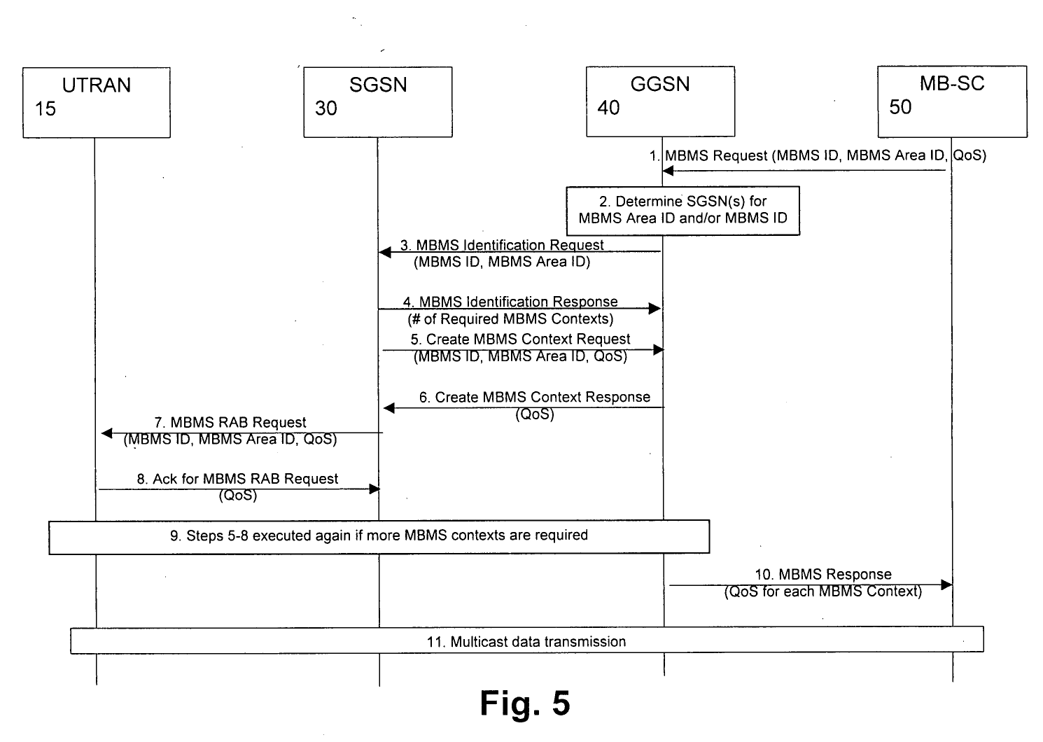

FIG. 5 shows a signaling and processing diagram according to a third example of the second preferred embodiment. In the third example, the number of RNCs involved in the MBMS service is also signaled by the separate signaling procedure, as indicated by steps 3 and 4 of FIG. 5. However, in this third example, the context activation request is issued by the SGSN 30 in step 5. Then, a context is first set up at the GGSN 40 which then issues a context activation response message to the SGSN 30 (step 6). In response thereto, the SGSN 30 requests a corresponding MBMS RAB from the UTRAN 15 (step 7) which responds an acknowledgement in step 8. These steps 5 to 8 are then repeated for every context or RNC involved (step 9). Then, the MBMS response message with QoS information for each MBMS context is forwarded by the GGSN 40 to the MB-SC 50 (step 10) which then starts the MBMS data transmission in step 11.

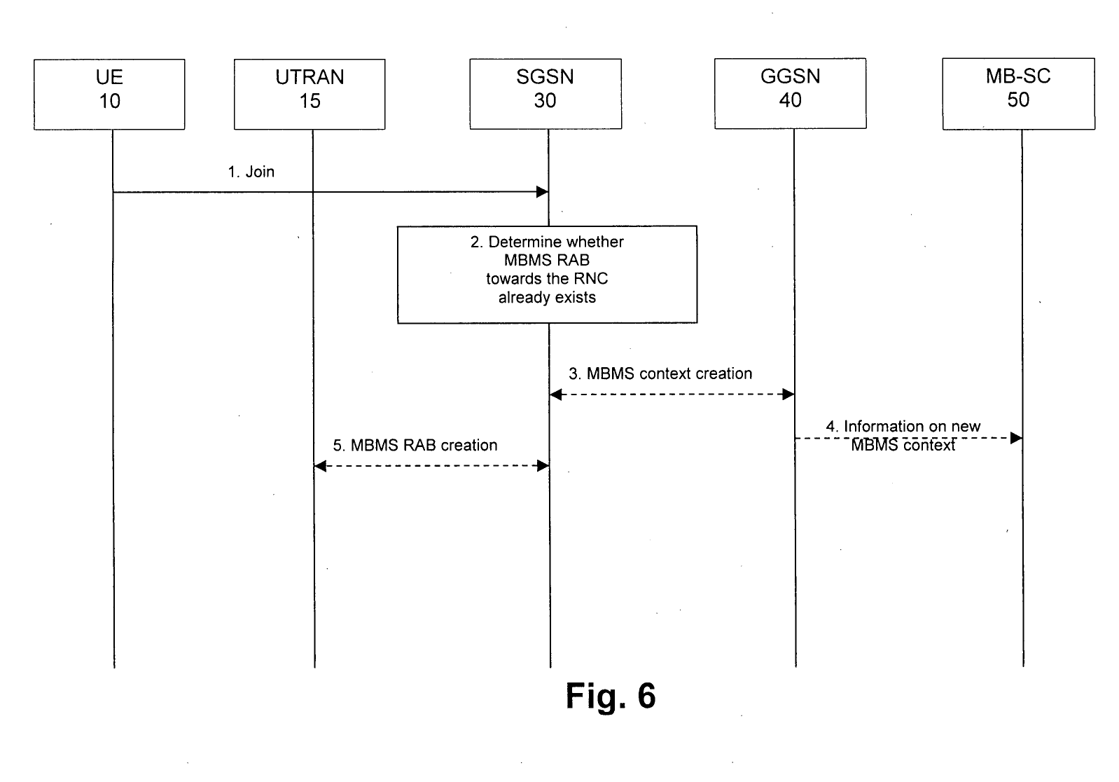

FIG. 6 shows a signaling and processing diagram indicating how the GTP tunnels are created if the UE 10 joins an MBMS service. In step 1, the UE 10 joins the MBMS service. The SGSN 30 checks whether an MBMS radio access bearer already exists towards the RNC serving the UE 10 in the UTRAN 15 (step 2). If the MBMS radio access bearer does not exist, the SGSN 30 performs MBMS context creation with the GGSN 40 and MBMS radio access bearer creation with the RNC in the UTRAN 15 (steps 3 and 5). At MBMS context creation, the GGSN 40 may inform the MB-SC 50 on the new MBMS context and e.g. on QoS information related to the new MBMS context (step 4).

In summary, according to the present invention, the GGSN 40 can get the information about the number of required RNCs or Iu GTP tunnels based on a memory access or network query or based on a signaling with the SGSN 30. Knowing the number of required GTP tunnels, a corresponding number of MBMS contexts can be activated from the GGSN 40.

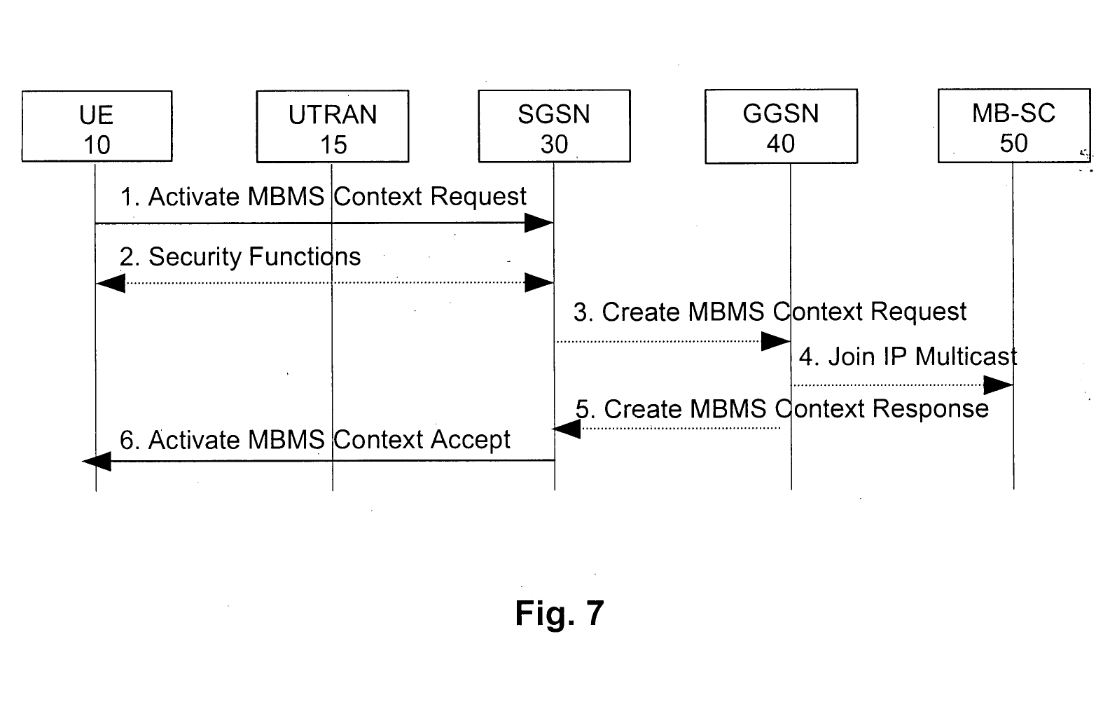

FIG. 7 shows a another example of the activation of an MBMS multicast service initiated by a terminal device, a UE 10. At MBMS context activation, the SGSN 30 requests as many Gn/Gp GTP tunnels towards the GGSN 40 as there will be Iu GTP tunnels at MBMS RAB setup. The activation procedure registers the user in the network to enable the reception of data from a specific MBMS multicast service. Hereby, the activation may be a signaling procedure between the UE 10 and the network, e.g. an UTRAN. It establishes the MBMS data transfer path within the network between SGSN(s) and MBMS data source, e.g. MB-SC. The MBMS multicast service activation does not establish any RABs for the data transfer. The procedure is similar to the PDP context activation.

In step 1, the UE 10 sends an Activate MBMS Context Request to the SGSN 30. The IP multicast address identifies the MBMS multicast service, which the UE 10 wants to join. An access point name (APN) indicates a specific GGSN 40. The SGSN 30 validates the Activate MBMS Context Request, determines the RNCs serving the routing area where the UE 10 is located and creates as many MBMS contexts as there are RNCs serving the routing area. The MBMS context(s) store the parameters of the activated MBMS multicast service. In step 2, security functions may be performed, e.g. to authenticate the UE 10. In step 3, if UE 10 is the first UE activating this specific MBMS multicast service on this routing area, the SGSN 30 determines the RNCs serving the routing area and requests for each the creation of an MBMS context on the GGSN 40 and the establishment of a GTP tunnel between the SGSN 30 and the GGSN 40. In step 4, if it is the first GTP tunnel for this specific MBMS multicast service on the GGSN 40, the GGSN 40 joins the IP multicast for the requested multicast IP address on the backbone to connect with the MBMS data source (BM-SC 50). In step 5, the GGSN 40 confirms the establishment of the MBMS context(s) if performed according to step 4. In step 6, the SGSN 30 sends an Activate MBMS Context Accept to the UE 10 with the parameter TMGI (temporary mobile group identity).

It is noted that the present invention can be used in any broadcast or multicast transmission system in any data network to adapt the number of connections between different switching nodes. Any information indicating the required number of users, controllers or connections can be provided to the concerned switching node. The preferred embodiments may thus vary within the scope of the attached claims.

1. A method of setting up a broadcast or multicast transmission to a plurality of terminal devices via a first switching node and a second switching node of a data network, said method comprising the steps of:
a) providing to said first switching node an information indicating the number of connections required between said second switching node and said plurality of terminals; and
b) determining based on said provided information a number of connections to be set up between said first switching node and said second switching node.

2. A method according to claim 1, wherein said number of connections to be set up between said first and second switching nodes is determined to be equal to said number of connections indicated by said provided information.

3. A method according to claim 1, wherein said broadcast or multicast transmission is a multimedia service transmission, said first switching node is a GGSN, and said second switching node is an SGSN.

4. A method according to claim 1, wherein said connections are tunnel connections.

5. A method according to any one of the preceding claims claim 1, wherein said providing step comprises the steps of setting up an initial connection between said first and second switching nodes and transmitting said information from said second switching node to said first switching node in response to a request of said first switching node.

6. A method according to claim 5, wherein said information is transmitted in a response message to a context activation request.

7. A method according to claim 5, wherein said information is transmitted in a response message to an identification request issued by said first switching node.

8. A method according to claim 7, wherein a context activation for said determined number of connections is requested by said first switching node in response to the receipt of said response message.

9. A method according to claim 7, wherein a context activation for said determined number of connections is requested by said second switching node after the transmission of said response message.

10. A method according to claim 1, wherein said providing step comprises the steps of storing said information in a memory table accessible by said first switching node.

11. A method according to claim 1, wherein said providing step comprises the steps of performing a query to an address server using an identification information or an area identification information of said broadcast or multicast transmission.

12. A system for setting up a broadcast or multicast transmission to a plurality of terminal devices via a first switching node and a second switching node of a data network,
a) wherein said first switching node is arranged to set up an initial connection to said second switching node, and
b) wherein said second switching node is arranged to transmit to said first switching node via said initial connection an information indicating the number of connections required between said second switching node and said plurality of terminals; and
c) wherein said first switching node is arranged to determine based on said provided information a number of connections to be set up between said first switching node and said second switching node.

13. A system according to claim 12, wherein said first switching node is a GGSN and said second switching node is an SGSN.

14. A system according to claim 12, wherein said second switching node is arranged to transmit said information in a response message to a context activation request issued by said first switching element.

15. A system according to claim 12, wherein said second switching node is arranged to transmit said information in a response message to a identification request issued by said first switching element.

16. A switching node for setting up a broadcast or multicast transmission to a plurality of terminal devices via another switching node of a data network,
a) wherein said switching node is arranged to access a memory table in order to derive an information indicating the number of connections required between said other switching node and said plurality of terminals; and
b) wherein said switching node is arranged to determine based on said derived information a number of connections to be set up to said other switching node.

17. A switching node for setting up a broadcast or multicast transmission to a plurality of terminal devices via another switching node of a data network,
a) wherein said switching node is arranged to query, using a multicast identification or a multicast area identification, from an address server an information indicating the number of connections required between said other switching node and said plurality of terminals; and
b) wherein said switching node is arranged to determine based on said queried information a number of connections to be set up to said other switching node.

18. A switching node according to claim 17, wherein said address server is a DNS.

19. A switching node according to claim 16 or 17, wherein said switching node is a GGSN.

20. A switching node according to claim 17, wherein said switching node is a GGSN.
